(19) United States
(12) Patent Application Publication
(10) Pub. No.: US 2009/0145680 A1
(43) Pub. Date: Jun. 11, 2009

(54) ROLL BAR EXHAUST SYSTEM

(76) Inventor: Justin WILSON, Red Lion, PA (US)

Correspondence Address: Charles L. Riddle, Esq., 434 Lackawanna Ave, Suite 200, Scranton, PA, 19465, US

(21) Appl. No.: 12/324,614

(22) Filed: Nov. 26, 2008

Related U.S. Application Data
(63) Continuation of application No. 61/005,641, filed on Dec. 6, 2007.

(51) Int. Cl. B60K 13/04; B60R 21/13

(52) U.S. Cl. 180/89.2; 280/748

(57) ABSTRACT

A roll bar exhaust system [1000] is described for retrofitting vehicles such as a pickup truck [100]. Two vertical pipes [1100] have exhaust conduits [1110] running through them which exit through exhaust outlets [1180] at their top side. Diagonal supports [1300] attach to a cross bar [1500] or the vertical supports [1100]. The diagonal supports also attach to the bed [110] of the vehicle. Exhaust conduits [1110] attach to elbows [1010] then to the engine exhaust [150]. Exhaust is routed from the engine exhaust [150] through the elbows [1010] up the exhaust conduit [1110] and out of the exhaust outlet [1180]. Since this is designed to have significant strength, it doubles as a roll bar system preventing the cab [130] of truck [100] from crushing and injuring passengers in the event of a roll over.

### CROSS REFERENCE TO RELATED APPLICATIONS

This application claims priority from U.S. Provisional Patent Application Ser. No. 61/005,641 “Roll Bar Exhaust System” filed Dec. 6, 2007 by the same inventor as the present application, Justin Wilson.

### FEDERAL SPONSORED RESEARCH

Not Applicable

### SEQUENCE LISTING OR PROGRAM

Not Applicable

### BACKGROUND OF THE INVENTION

1. Field of the Invention

The present invention relates to an exhaust system for a vehicle which also protects the vehicle and its occupants in the event that the vehicle rolls over.

2. Discussion of Related Art

Off road vehicles are usually higher to allow for more ground clearance. This allows them to drive over rocks and other obstructions without incident.

By increasing the height of the vehicle, it makes them more prone to rolling over. The problem becomes worse when the vehicle is on an uneven road or trail.

Typically, a support bar system is bolted to the vehicle which extends over the vehicle cab. It is made of bars strong enough to support the entire vehicle in the event that it rolls over. The roll bar system protects the cab from being crushed and injuring the occupants inside of the cab.

Exhaust systems are designed to route exhaust from the engine to the rear of the vehicle. Since the exhaust is toxic, it must be air-tight.

The exhaust is typically hot and makes the exhaust system heat up also. Parts of the exhaust system become so hot that it burns off normal paint. Petroleum-based anti-corrosives also burn off when heated, and produce unpleasant odors and toxic vapors.

Therefore, corrosion of exhaust systems is common. For this reason and other aesthetic reasons, trucks have been fitted with exhaust stacks. These are typically chromed.

One prior art device was U.S. Pat. No. 4,029,167 Fox et al. This described an exhaust system built into the front of a cab of land moving equipment. It was made to protect the cab from crushing in the event of a large force impacting the cab. Since this was designed to be at the front of the cab, it has a geometry which will work for land moving equipment, but not for SUVs and pickup trucks, which are both more prone to rolling over.

For pickup trucks, exhaust stacks are usually positioned close to the roll bar. Sometimes there is not enough room to have both installed. Sometimes a choice must be made between the roll bar or the exhaust stacks.

Also, it can become fairly expensive to install both a roll bar and exhaust stacks.

Currently, there is a need for an inexpensive device which protects a vehicle in the event of a rollover which may be incorporated into the existing structure of the vehicle.

### SUMMARY OF THE INVENTION

One embodiment of the present invention is a roll bar exhaust device [1000] connected to an exhaust pipe [150] of a vehicle [100], the exhaust device [1000] functioning to protect the vehicle [100] and its passengers, comprising:
a) at least two vertical supports [1100] having a top end and bottom end wherein the bottom ends are attached to the vehicle [100],
b) an exhaust conduit [1110] passing through the vertical support [1100] and having an upper end which extends to the top side of the vertical supports [1100] and extends out of the bottom ends of the vertical supports [1100] connecting to the vehicles exhaust [150], for directing exhaust from the exhaust pipe [150] out of the exhaust conduits [1110].

The invention may also be embodied as a reinforced exhaust device [1000] for directing engine exhaust out of a vehicle [100] exhaust pipe [150] and for protecting the vehicle [100] in the event of a rollover comprising:
a) a reinforced vertical support [1100] capable of supporting said vehicle, having a top exhaust outlet [1180] and an internal passageway through which exhaust gasses may flow;
b) an elbow section [1190] for connecting the exhaust pipe [150] to said vertical support [1100] allowing exhaust gasses to flow from the exhaust pipe [150] through the elbow section [1190] through the vertical supports [1100] and out of the exhaust outlet [1180].

### OBJECTS OF THE INVENTION

It is an object of the present invention to provide roll-over protection to the vehicle.

It is another object of the present invention to provide an optimized exhaust system for the vehicle.

It is another object of the present invention to provide to combine roll-over protection in the exhaust system into a compact unit.

It is another object of the present invention to use a single device for both protecting a vehicle and for exhaust routing purposes.

It is another object of the present invention to route the exhaust in a safer manner.

It is another object of the present invention to provide free flowing customized exhaust system for vehicles.

It is another object of the present invention to provide an exhaust system which also acts as a safety support in the event of a vehicle rollover.

It is another object of the present invention to provide a roll bar system which routes the exhaust out of the vehicle.

It is another object of the present invention to provide a system which modifies the exhaust sound to become aesthetically pleasing.

### BRIEF DESCRIPTION OF THE DRAWINGS

The advantages of the instant disclosure will become more apparent when read with the specification and the drawings, wherein:

FIG. 1 is a partial perspective view of one embodiment of the roll bar exhaust system 1000 according to the present invention as it would appear installed on a pickup truck.

FIG. 2 is a side elevational view of the roll bar exhaust system 1000 of FIG. 1.

FIG. 3 is a plan view of the roll bar exhaust device 1000 shown in FIGS. 1 and 2 as viewed from above.

FIG. 4 is a plan view of another embodiment of the roll bar exhaust device 1000 according to the present invention.

FIG. 5 is a plan view of another embodiment of the roll bar exhaust device 1000 according to the present invention.

FIG. 6 is a plan view of the roll bar exhaust device 1000 similar to that shown in FIG. 3 as viewed from above.

### DETAILED DESCRIPTION OF THE INVENTION

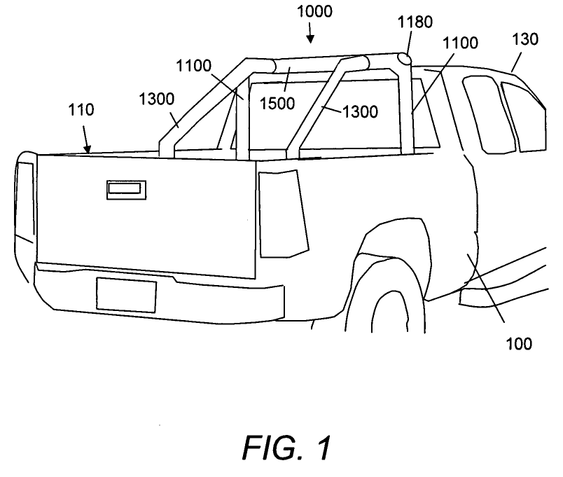

FIG. 1 is a partial perspective view of one embodiment of the roll bar exhaust system 1000 according to the present invention as it would appear installed on a pickup truck 100.

Roll bar system 1000 is shown here attached to a bed 110 of truck 100. The roll bar system includes two vertical support bars 1100 extending upward to a top side having exhaust outlets 1180.

There is also at least one cross bar 1500 secured between at least two vertical supports 1100.

At least one diagonal support 1300 attaches to either of the vertical support pipes 1100 to the cross bar 1500. The diagonal supports 1300 also attach to the bed 110 with attachment plates (not shown here). The diagonal supports 1300 secure the cross bar 1500 and the vertical supports 1100.

Cross bar 1500 and/or vertical supports 1100 should extend vertically at least to the top of a cab 130 of truck 100 thereby holding up the truck 100 in the event of a roll over. This protects the cab 130 from being crushed and injuring its occupants.

Exhaust from an engine of the truck 100 is routed into the lower end of the vertical support pipes 1100, through an internal exhaust conduit (not shown here) and out of the exhaust outlets 1180 at the top of the vertical pipes 1100. Thereby, the roll bar exhaust system 1000 performs two functions, a) acting as an exhaust conduit and b) protecting the cab 130 of truck 100 from being crushed in the event of a rollover.

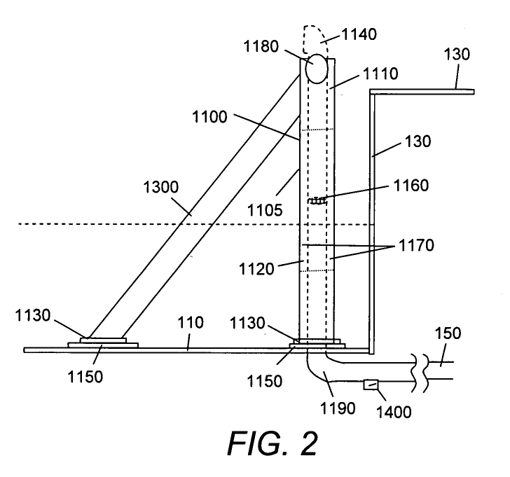

FIG. 2 is a side elevational view of the roll bar exhaust system 1000 of FIG. 1. The bed 110 and cab 130 of truck 100 are shown.

Here it is seen that vertical supports 1100 are comprised of an inner pipe which is an exhaust conduit 1110 and an outer pipe 1105 which is used for mechanical support and protection.

Since the roll bar exhaust system is connected to the engine exhaust pipe 150, the systems must be modified to be able to handle the heat. There is a space 1170 between exhaust conduit 1110 and outer pipe 1105 preferably filled in with an insulation material 1120 to reduce the heat transmitted to the outer pipe 1105. This prevents a user from getting burned if they touch the outer pipe 1105 while loading or unloading the vehicle.

Insulation material 1120 may also be a sound dampening material. This is used to add an aesthetic sound to the exhaust.

Diagonal supports 1300 attach to cross bar (1500 of FIG. 1) or the vertical supports 1100. Diagonal supports 1300 also attach to the bed 110 through attachment plates 1130. Preferably, diagonal support 1300 and vertical supports 1100 are attached to an attachment plate 1130 which is attached to the vehicle's bed 110. A vibration dampener 1150 may also be used which dampens the vibrations from the truck engine.

An engine exhaust 150 connects to an elbow 1010 which is connected to exhaust conduit 1110 which travels up through an opening in bed 110, through the vertical supports 1100 to the exhaust outlet 1180. This allows engine exhaust to flow from the engine through the exhaust conduits 1110 of the vertical supports 1100 and out of the exhaust outlet 1180. In an alternative embodiment, an exhaust tip 1140, shown in phantom, may be employed.

This side view may apply to either a single or double engine exhaust pipe 150.

Condensation collects in the pipe and causes corrosion. Therefore, the system may optionally include a water release valve 1400 to empty the water in the system, reducing corrosion and increasing the life of the system.

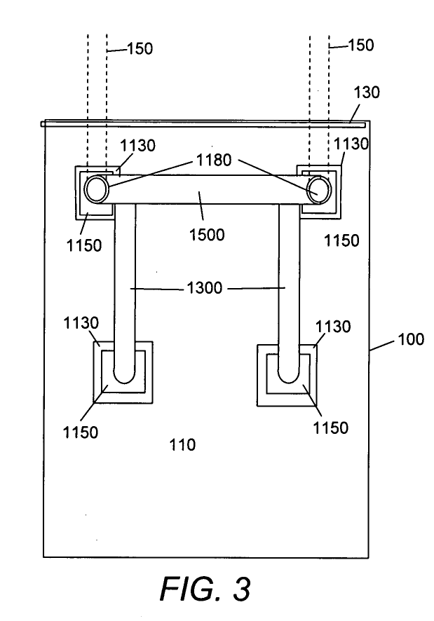

FIG. 3 is a plan view of the roll bar exhaust device 1000 shown in FIGS. 1 and 2 as viewed from above. All parts with the same reference numbers as in the previous figures perform the same function as described above.

Diagonal supports 1300 are seen attached to truck bed 110 and the cross bar 1500.

In this embodiment, truck 100 has a dual exhaust system. Engine exhaust pipes 150 each connect to the elbow (not shown) then to the exhaust conduits of the vertical supports.

The exhaust then travels through the vertical supports (1100 of FIGS. 1, 2) and out of the exhaust outlets 1180.

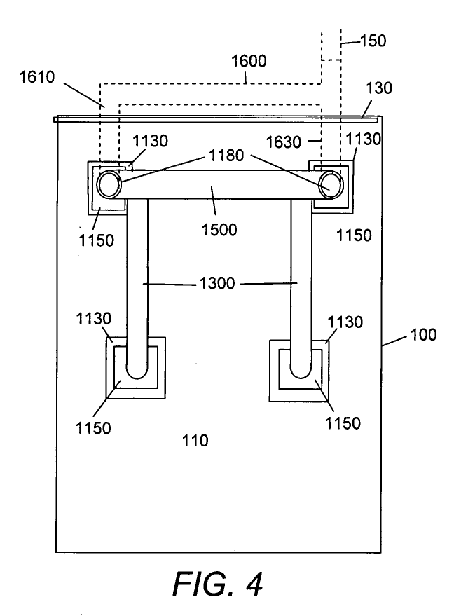

FIG. 4 is a plan view of another embodiment of the roll bar exhaust device 1000 according to the present invention. In this embodiment, it is shown how a single engine exhaust pipe 150 is adapted to be used with the present invention.

Again, all parts with the same reference numbers as in the previous figures perform the same function as described above.

Diagonal supports 1300 are seen attached to the cross bar 1500 and to bed 110.

The engine exhaust pipe 150 is shown coming in only from the right side. A “Y” connector 1600 attaches to the engine exhaust pipe 150 and splits into a left connection 1610 and a right connection 1630. The left and right connections 1610, 1630 attach to the elbows (1010 of FIG. 2). Exhaust gasses are then routed through the exhaust conduits (1110 of FIG. 2) and out of exhaust outlets 1180.

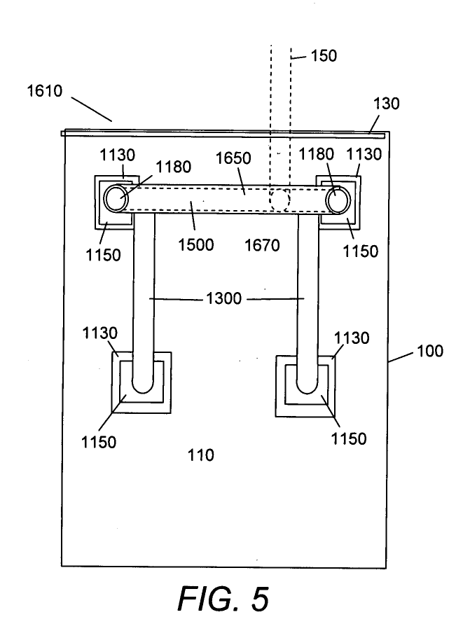

FIG. 5 is a plan view of another embodiment of the roll bar exhaust device 1000 according to the present invention. In this embodiment, it is shown how a single engine exhaust pipe 150 is used with the present invention.

Again, all parts with the same reference numbers as in the previous figures perform the same function as described above.

Diagonal supports 1300 are seen attached to the cross bar 1500 and to bed 110.

The engine exhaust pipe 150 is shown coming in slightly from the right side. A cross connector 1650 is attached to the engine exhaust pipe 150 at connection point 1670. Cross connector then connects on each side to exhaust conduits (1110 of FIG. 2).

Exhaust gasses are then routed through the exhaust conduits (1110 of FIG. 2) and out of exhaust outlet 1180.

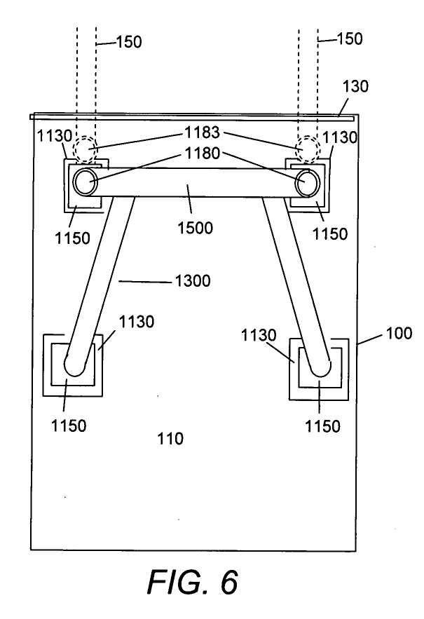

FIG. 6 is a plan view of the roll bar exhaust device 1000 similar to that shown in FIG. 3 as viewed from above. All parts with the same reference numbers as in the previous figures perform the same function as described above.

Diagonal supports 1300 are seen attached to truck bed 110 and the cross bar 1500. For added strength, the diagonal supports are angled toward the outside of bed 110.

In this embodiment, truck 100 has a dual exhaust system. Engine exhaust pipes 150 each connect to the elbow (not shown) then to the exhaust conduits 1110 of the vertical supports 1100.

The exhaust then travels through the vertical supports (1100 of FIGS. 1, 2) and out of the exhaust outlets 1180.

In an alternative embodiment as shown in phantom in FIG. 6, there are more than two vertical support pipes, such as quad pipes. Here it can be seen that two additional vertical supports end at additional exhaust outlets 1183. The additional vertical supports may branch off of the vertical supports above or below the truck bed 110. These may be made to connect to a single or dual exhaust system of the truck 100.

The present invention was described above with respect to a pickup truck; however, it may be used with sport utility vehicles, sedans, vans, minivans, etc., as long as the exhaust outlets 1180 are directed out of the cab 130.

Since some of the aesthetic qualities of the system involve the exhaust noise, it is important to modify the engine noise. In an alternative embodiment as shown in FIG. 2, at least one resonator baffle 1160 may be inserted into the exhaust conduit 1110.

The resonator baffle 1160 may be designed or adjusted to allow more or less exhaust gas passage. These may be used to muffle or alter the sound.

By adjusting the location of the resonator baffle 1160, different resonant exhaust sounds may be made. Resonator baffle 1160 may be made on a slider and is allowed to slide up and down the inside of the exhaust conduit 1110.

This will accentuate different resonant frequencies and provide different exhaust sounds.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A roll bar exhaust device [1000] connected to an engine exhaust pipe [150] of a vehicle [100], the exhaust device [1000] functioning to protect the vehicle [100] and its passengers, comprising:
a) at least two vertical supports [1100] having a top end and bottom end wherein the bottom ends are attached to the vehicle [100],
b) an exhaust conduit [1110] passing through the vertical support [1100] and having an upper end which extends to the top side of the vertical supports [1100] and extends out of the bottom ends of the vertical supports [1100] connecting to the vehicle's engine exhaust pipe [150], for directing exhaust from the engine exhaust pipe [150] out of the exhaust conduits [1110].

2. The roll bar exhaust device [1000] of claim 1, further comprising:
at least one diagonal support [1300] attached between at least one of the vertical supports [1100] and the vehicle [100] thereby providing added support to the vertical support [1100],

3. The roll bar exhaust device [1000] of claim 1, further comprising:
a cross bar [1500] connected between the vertical supports [1100] for providing additional support to vertical supports [1100].

4. The roll bar exhaust device [1000] of claim 1, wherein the engine exhaust pipe [150] is a single exhaust and the roll bar exhaust device [1000] further comprises:
a “y” connector having a single pipe which branches into two pipes in which the single pipe is connected to the engine exhaust pipe [150] and each of the two branch pipes is fluidically connected to vertical supports [1100].

5. The roll bar exhaust device [1000] claim 1, further comprising:
a vibration dampener [1150] coupled to the vertical supports [1100] for limiting engine vibration transmitted through the engine exhaust pipe [150].

6. The roll bar exhaust device [1000] claim 1, further comprising:
a resonator baffle [1160] within the exhaust device [1000] capable of being positioned at different locations within the exhaust device [1000] to create an aesthetically pleasing exhaust sound.

7. The roll bar exhaust device [1000] claim 1, wherein:
the vertical supports [1100] extend vertically to the highest point of the vehicle [100].

8. The roll bar exhaust device [1000] claim 1, further comprising:
a water release valve [1400] to release condensation within the roll bar exhaust device [1000].

9. A reinforced exhaust device [1000] for directing engine exhaust out of a vehicle [100] exhaust pipe [150] and for protecting the vehicle [100] in the event of a rollover comprising:
a) a reinforced vertical support [1100] capable of supporting said vehicle, having an exhaust outlet [1180] and an internal passageway through which exhaust gasses may flow;
b) an elbow section [1190] for connecting the exhaust pipe [150] to said vertical support [1100] allowing exhaust gasses to flow from the engine exhaust pipe [150] through the elbow section [1190] through the vertical supports [1100] and out of the exhaust outlet [1180].

10. The reinforced exhaust device [1000] of claim 9, further comprising:
at least one diagonal support [1300] attached between at least one of the vertical supports [1100] and the vehicle [100] thereby providing added support to the vertical support [1100].

11. The reinforced exhaust device [1000] claim 9, further comprising:
a cross bar [1500] connected between the vertical supports [1100] for providing additional support to vertical supports [1100].

12. The reinforced exhaust device [1000] claim 9, wherein the exhaust pipe is a single exhaust and the roll bar exhaust device [1000] further comprises:
a “y” connector having a single pipe which branches into two pipes in which the single pipe is connected to the engine exhaust pipe [150] and each of the two branch pipes is fluidically connected to vertical supports [1100].

13. The reinforced exhaust device [1000] claim 9, further comprising:
A vibration dampener [1150] coupled to the vertical supports [1100] for limiting engine vibration transmitted through the engine exhaust pipe [150].

14. The reinforced exhaust device [1000] claim 9, further comprising:
a resonator baffle [1160] within the exhaust device [1000] capable of being positioned at different locations within the exhaust device [1000] to create an aesthetically pleasing exhaust sound.

15. The reinforced exhaust device [1000] claim 9, wherein:
the vertical supports [1100] extend vertically to the highest point of the vehicle [100].

16. The reinforced exhaust device [1000] claim 9, further comprising:
a water release valve [1400] to release condensation within the roll bar exhaust device [1000].
